(19) United States
(12) Patent Application Publication
(10) Pub. No.: US 2007/0187326 A1
(43) Pub. Date: Aug. 16, 2007

(54) Membrane filter cleaning method and installation for implementing same

(75) Inventors: Veronique Bonnelye, Conflans Sainte Honorine (FR); Marc Petry, Chatou (FR); Frederic Colas, Saint Denis Le Ferment (FR)

Correspondence Address: CONNOLLY BOVE LODGE & HUTZ LLP, 1875 EYE STREET, N.W., SUITE 1100, WASHINGTON, DC, 20036, US

(73) Assignee: Degremont, Reul-Malmaison (FR)

(21) Appl. No.: 10/592,152

(22) PCT Filed: Mar. 1, 2005
(86) PCT No.: PCT/FR05/00486

§ 371 Date: Mar. 8, 2007

(30) Foreign Application Priority Data
Mar. 10, 2004 (FR) 0402492

(51) Int. Cl. B01D 65/02

(52) U.S. Cl. 210/636; 210/639; 210/321.69

(57) ABSTRACT

The invention relates to a method of cleaning membrane filters comprising hollow fibres and an inner skin. The inventive method comprises the following steps consisting in: emptying the concentrate compartment in order to release the liquid to be filtered contained therein and the suspended matter, and, subsequently, performing a backwashing step involving the passage of liquid from the permeate compartment into the concentrate compartment through membranes in order to detach and release impurities deposited thereon, while circulating a gas in the concentrate. According to the invention, backwashing liquid and/or gas pulses are produced by control means (5, 5a; 7, 7a) during at least one backwashing phase.

The invention relates to a method for cleaning membrane filters comprising hollow fibers with an inner skin, mounted inside a housing, with delimitation of a concentrate compartment where the materials retained both in suspension and on the membranes accumulate, and a permeate compartment collecting the filtered liquid.

The filtration of liquids, particularly water, generates a cake composed of particles and fractions of solutes retained by the membrane. This filter cake can cause clogging of the membrane, resulting in an increase in the transmembrane pressure at constant permeate flow rate, or a drop in permeate flow rate at constant transmembrane pressure.

Methods for reducing clogging are employed to remove this filter cake. A backpermeation is generally performed, with the introduction of permeate in the opposite direction from the filtration direction applied in production, the filter cake thereby being entrained by the one-phase liquid flow. However, the efficiency of these methods is limited in time, and this can cause the formation of a filter cake that withstands these detachment methods. This situation leads to the implementation of other methods, called chemical regeneration methods, involving the use of costly and polluting chemical reagents and which require time for carrying out these washings (extra operating cost). The production downtimes thereby caused and the water losses generated require oversizing of the installation to guarantee the nominal production throughput, hence an additional investment cost.

Many proposals have been made to improve the methods for cleaning or for hydraulic unclogging of membrane filters.

Japanese patent application JP 100089842, filed 25 Feb. 1994, describes a simple backwashing method comprising steps consisting in:
draining the concentrate compartment to remove the liquid to be filtered contained therein and the suspended matter, then
performing a backwashing step by passing liquid from the permeate compartment to the concentrate compartment through the membranes to detach and remove the impurities deposited thereon, while circulating a gas in the concentrate.

According to this document, an air injection is provided on the concentrate side, supplemented by a water injection in the opposite direction from the filtration direction, the air being introduced through one end of the membrane, and the filter cake removed at the opposite side. This method serves to improve the unclogging of ultrafiltration membranes. However, its efficiency needs to be improved and maintained over time.

FR-A-2 668 078, also, teaches a method using filtered water, possibly augmented with chlorine, sent in the opposite direction from the filtration direction with alternating phases in order to improve the detachment and removal of the materials forming the filter cake. Here, also, the efficiency of the method needs to be improved.

It is a primary object of the invention to provide a method for cleaning membrane filters which serves to reduce the duration of the unclogging procedure and which provides an increased and durable gain in permeability, while remaining simple and economical to implement.

According to the invention, a method for cleaning membrane filters comprising hollow fibers with an inner skin, mounted inside a housing for filtering a liquid, with delimitation of a concentrate compartment where the materials retained both in suspension and on the membranes accumulate, and a permeate compartment collecting the filtered liquid, comprises the steps consisting in:

a) draining the concentrate compartment to remove the liquid to be filtered contained therein and the suspended matter, then

b) performing a backwashing by passing liquid from the permeate compartment to the concentrate compartment through the membranes to detach and remove the impurities deposited thereon, while circulating a gas in the concentrate,

and is characterized in that backwashing gas and/or liquid pulses are produced during at least one backwashing phase.

The number of pulses during backwashing may be between 1 and 10. The pulse duration may be between 2 and 60 seconds, and, similarly, the interval between two pulses can itself last between 2 and 60 seconds.

Preferably, the washing liquid is injected in pulses from the permeate compartment into the concentrate compartment while the circulation of gas, particularly air, is maintained in the concentrate compartment. As a variant, the gas may be injected in pulses into the concentrate compartment while the circulation of liquid is maintained in the concentrate.

During the backwashing step, the rate of passage of the liquid in the hollow fibers may be between 0.1 and 1 m³/m².s (generally expressed in the form of speed in m/s), while the rate of passage of the gas may be between 0 and 4 Sm³/m².s (4 m/s).

The concentrate compartment drainage step may comprise the use of a gas stream to accelerate and improve the drainage.

Generally, the liquid to be filtered (production phase) is water, the liquid used for the backwashing step is filtered water, and the gas circulated is air.

The filtered liquid injected during the backwashing step into the concentrate compartment through the membranes may previously be augmented with one of the following products: disinfectant, oxidizing agent (for example hypochlorite, chlorine dioxide, peroxides, etc.), acidic or basic chemical compound.

Preferably, the backwashing step comprises at least one two-phase cycle, that is, one phase with two fluids, liquid and gas, one of which is pulsed, and another phase with the fluid that is not pulsed. The number of two-phase cycles during a single backwashing step is between 1 and 10.

The invention further relates to an installation for implementing the method defined above; this installation comprises membrane filters in the form of hollow fibers with an inner skin mounted inside a housing, with delimitation of a concentrate compartment and a permeate compartment, a feed pump and a feed valve for the concentrate compartment, a drain valve, a backwashing pump and a backwashing valve, a gas compressor and a valve connected to the concentrate compartment, characterized in that it comprises a control means for pulsing the flow of backwashing liquid and/or gas which can circulate in the concentrate compartment.

The pulse control means may comprise a solenoid valve and a circuit for supplying said solenoid valve with electrical pulses.

Apart from the arrangements described above, the invention comprises a number of other arrangements more explicitly described below, with reference to an exemplary embodiment described with reference to the drawings appended hereto, but which is non-limiting.

In these drawings:

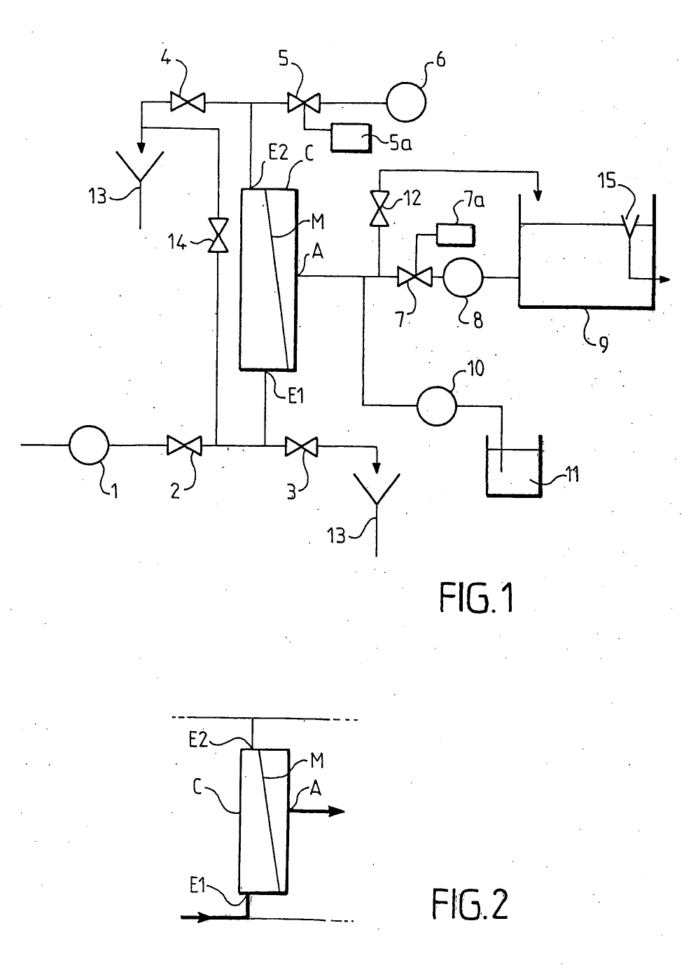

FIG. 1 is a flowchart of a filtration installation implementing the method of the invention.

FIG. 2 is a partial operating diagram in filtration mode.

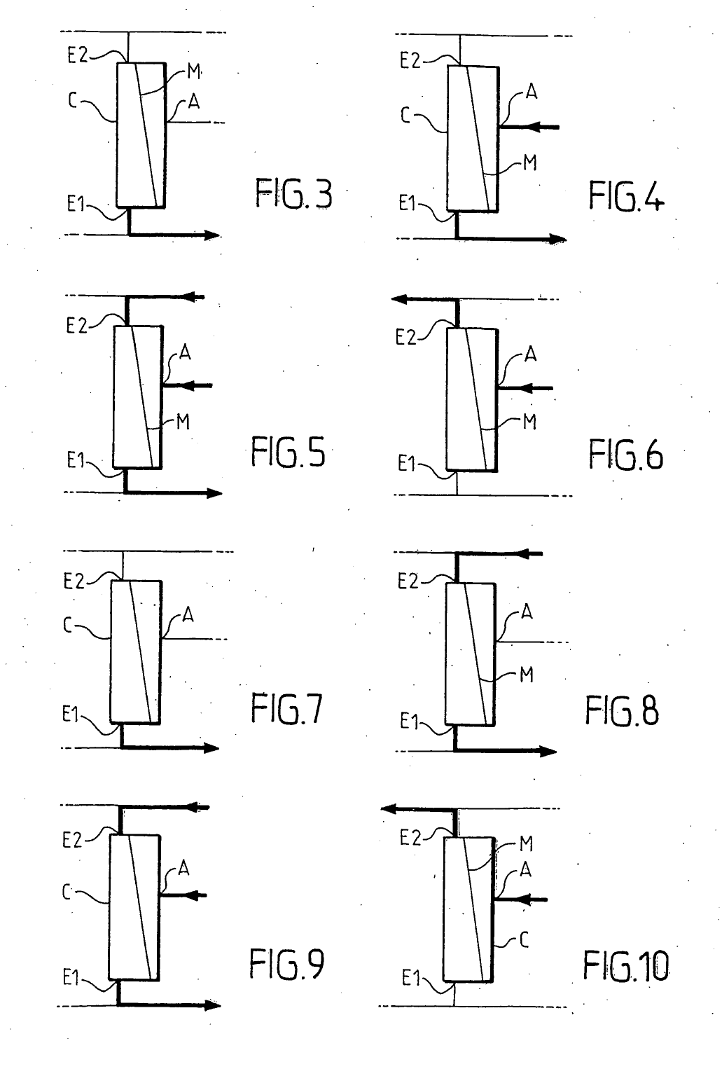

FIGS. 3 to 6 show partial diagrams illustrating four successive backwashing phases with water with pulsed air.

FIGS. 7 to 10 show partial diagrams illustrating four successive backwashing phases with air with pulsed water.

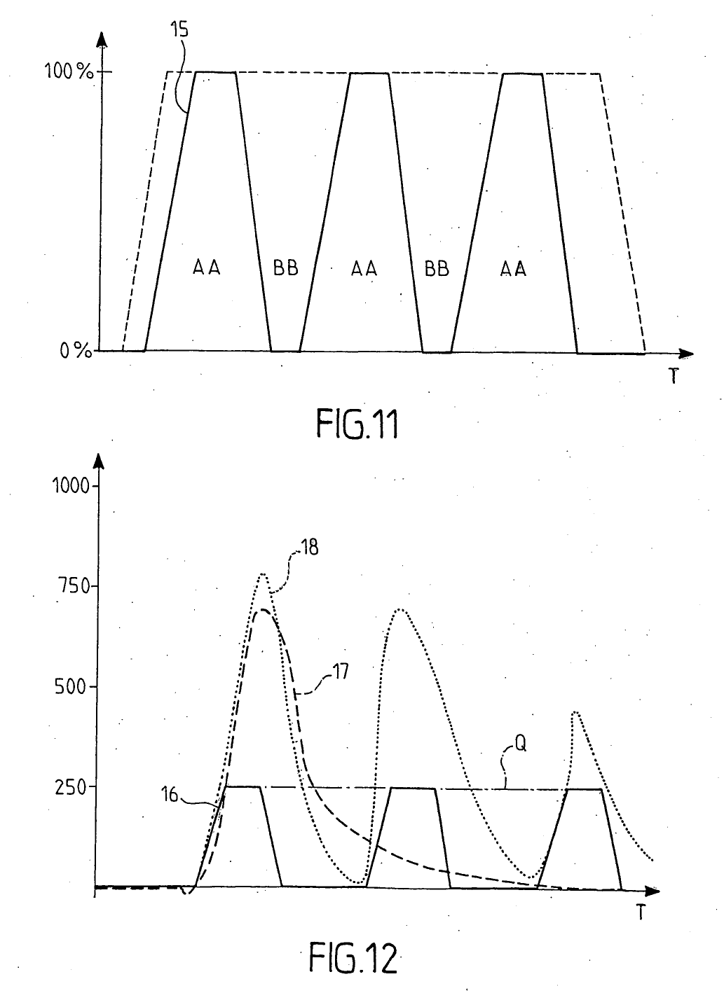

FIG. 11 is an operating diagram of a backwashing with three pulses; time is plotted on the x-axis and the ratio of the flow rate/maximum flow rate of the sequence is plotted on the y-axis.

FIG. 12 is a comparative diagram of the releases of the various backwashing modes with time plotted on the x-axis; on the y-axis are plotted the backwashing water stream as a solid line, and the suspended matter concentration, expressed in mg/l, as dotted and dashed curves, and

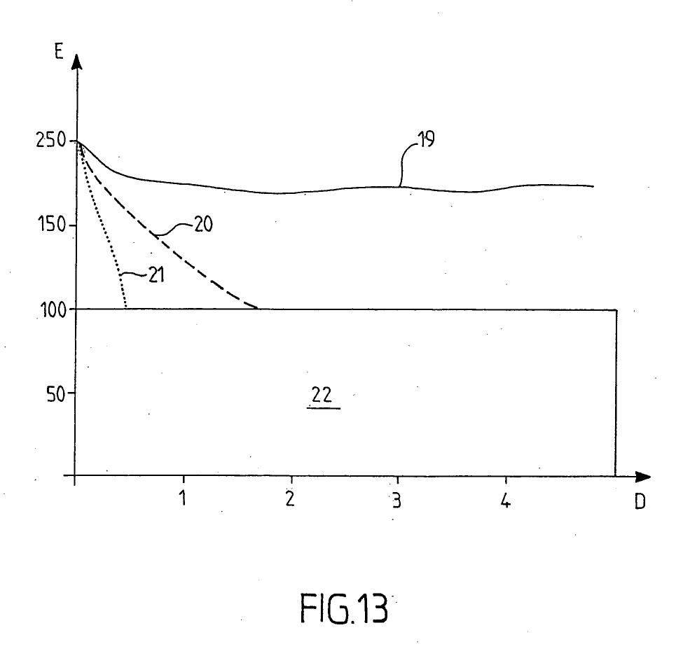

FIG. 13 is a comparative diagram of the various backwashing modes with the filtration time expressed in weeks plotted on the x-axis, and the filtration permeability expressed as l/h.m².bar on the y-axis.

Reference to the drawings, particularly to FIG. 1, shows an installation for implementing a method according to the invention for unclogging filtration, ultrafiltration, microfiltration, nanofiltration or hyperfiltration membranes. The set of M membranes, shown schematically in FIG. 1, has a tubular geometry, and is placed in a housing C containing a set of hollow fibers with an inner skin. The housing C is equipped with two orifices E1, E2, respectively bottom and top, which can serve as outlets and/or inlets. The orifices E1, E2 are connected to the concentrate compartment formed by the inner space of the hollow fibers. Inside the housing, the space around the membranes, and between them, forms the permeate compartment which comprises an outlet A at mid-height of the module. As a variant, the outlet A may be axial with respect to the module diameter.

The membranes M are used for filtering liquids, typically water, and for retaining particles or solutes with molecular weights higher than the cutoff threshold of the membranes concerned.

The installation comprises a feed pump 1 for pumping the liquid to be filtered, with its discharge connected, via a feed valve 2, to the orifice E1. A drainage branch between the valve 2 and the orifice E1 is provided with a drain valve 3. The line located downstream of the valve 3 terminates in a waste removal device 13.

A top backwashing discharge valve 4 is connected to the orifice E2 of the housing C. A line downstream of the valve 4 terminates in the device 13.

A valve 5 is mounted on a line connecting a gas compressor 6, particularly an air compressor, to the orifice E2. A backwashing valve 7 is placed on a line connecting the outlet of a backwashing pump 8 to the orifice A. The suction side of the pump 8 is connected to a filtered liquid tank 9. A pump 10 has its suction side connected to a tank 11 containing an additive, for example a disinfectant, oxidizing agent (for example hypochlorite, dioxide, etc.) solution, or an acidic or basic chemical compound. The delivery side of the pump 10 is connected to part of the line located between the valve 7 and the inlet A.

A production valve or backwashing recirculating valve 12 is placed on a line located between the valve 7 and the orifice A. The valve 12 is connected downstream to a line which terminates in the filtered water tank 9. An overflow 15 is provided to remove the treated water to the application.

The various valves of the installation are solenoid valves, most of the control circuits of which have not been shown for the sake of simplification.

The solenoid valve 5 of the gas compressor and/or the backwashing solenoid valve 7 are associated with an electrical pulse control means 5a, 7a for implementing a predefined sequence of valve openings and closings. The pulses can be implemented by means of the valves 5 and 7, associated with distribution devices such as:
electronic starters or variable-speed units on the pumps 6 and 8, or
recycling circuits, with, for example, syncopated opening of the valve 12.

The operation of the installation according to the method of the invention is now described.

In filtration mode, illustrated by FIG. 2, the pump 1 is in action and the valves 2 and 12 are open while all the other valves are closed. The liquid to be processed enters via the orifice E1 and the filtered liquid (permeate) leaves via the orifice A in the direction of the tank 9.

The cleaning of the membrane M by backwashing can be performed with water, with pulsed air according to the steps in FIGS. 3 to 6.

In general, in the diagrams, the fluid flow lines are represented by a thicker line, with an arrow indicating the flow direction.

The diagram in FIG. 3 corresponds to a concentrate gravity drainage phase. The pump 1 (FIG. 1) is stopped, the valve 2 is closed, while the valve 3 is opened, the other valves are closed, and the pumps 8 and 10 are stopped.

The drainage phase in FIG. 3 lasts between 5 and 60 seconds.

Optionally, this gravity drainage can be assisted by gas injection, with opening of the valve 5 and inlet of the gas via the orifice E2.

The subsequent phases in FIGS. 4 and 5, the succession in time of which can be reversed (sequence 3-4-5 or 3-5-4), constitute a cycle which can be repeated several times.

The phase illustrated by FIG. 4 corresponds to an injection of backwashing filtered water via the orifice A, the pump 8 being activated and the valve 7 being open. Drainage takes place via the orifice E1 and the open valve 3.

The phase illustrated by FIG. 5 corresponds to an injection of backwashing filtered water with, according to the invention, pulsed air. The backwashing water is again injected via the orifice A. Moreover, the solenoid valve 5 is successively opened and closed by a series of pulses corresponding to the pulses 15 in FIGS. 11 and 16 in FIG. 12, trapezoidal in this example (but which may also be square, triangular or sinusoidal).

Surprisingly, the succession of transitory phases created by the air pulses significantly increases the removal of the filter cake in comparison to a constant flow.

The water flow rate during the backwashing step is typically between 100 and 850 l/h.m² (liters per hour and per m² of membrane area). The preferred values are between 250 and 400 l/h.m².

The air speed in the concentrate compartment is typically 0 to 4 Sm³/m².s. The preferred values are between 0 and 1 Sm³/m².s (zero speed corresponding to the one-phase backwashing periods).

The duration of the water+air phase is typically between 2 and 60 seconds. The preferred values are between 5 and 30 seconds. The duration of the “water only” phase is typically between 2 to 60 seconds, the preferred values also being between 5 and 30 seconds.

The next phase, illustrated in FIG. 6, corresponds to the end of the backwashing step with injection of filtered water via the orifice A, flooding of the housing C; all the valves are closed with the exception of the valve 7 and the valve 4 used to drain the housing C.

The diagrams in FIGS. 7 to 10 illustrate an operating variant corresponding to a backwashing with air with water pulse.

The drainage phase illustrated by FIG. 7 is identical to that of FIG. 3.

The next phases, in FIGS. 8 and 9, constitute the backwashing cycle AA+BB (as defined in FIG. 11), which can be repeated several times.

The phase illustrated by FIG. 8 corresponds to a backwashing with air only. The valve 5 (FIG. 1) is open for the inlet of air via E2 and the valve 3 is also open for the removal of the filter cake. The other valves are closed, particularly the valve 7.

According to the phase illustrated by FIG. 9, the air circulation continues as shown in FIG. 8 but, in addition, filtered water is injected via the orifice A with pulses produced by the successive openings and closings of the solenoid valve 7 (FIG. 1), the pump 8 being activated. The washing water pulses correspond to the pulses 15 and 16 in FIGS. 11 and 12.

The final phase, illustrated by FIG. 10, is identical to that in FIG. 6, and corresponds to a filtered water injection with water flooding and drainage.

During a cleaning operation, the cycles corresponding to the phases in FIGS. 4 and 5 or FIGS. 8 and 9 can be repeated several times. The number of cycles may vary between 1 and 10. The number of cycles is preferably between 2 and 7.

FIG. 11 is a diagram illustrating the operation. Time T is plotted on the x-axis, and the ratio (expressed as a percentage) of the flow rate of fluid concerned to the maximum flow rate of this fluid during the sequence is plotted on the y-axis.

The zones marked “AA” correspond to pulses, while the intervals are marked “BB”. The pulses are two-phase with simultaneous injection of gas and water, while the injections are one-phase, either gas or water. The trapezoidal shape of the pulses in FIG. 11 is merely indicative and could equally well be square, triangular or sinusoidal. In this FIG. 11, the dotted outline represents the continuous injection of one of the washing fluids, generally water, and the “sawtooth” 15 correspond to the introduction of the second fluid, generally gas. Hence there are clearly periods during which the second fluid is stopped, hence at zero flow rate, thereby justifying the speed range of 0 to 4 m/s.

In the example corresponding to FIG. 11, three pulses are provided for one cycle.

FIG. 12 is a comparative diagram of the releases of the various backwashing modes. Time T is plotted on the x-axis. The concentrations of suspended matter in the releases expressed in mg/l are plotted on the y-axis. The dashed curve 17 corresponds to a backwashing with air and water, without pulsings, for a constant backwashing water flow rate Q corresponding to the apices of the pulses 16. The dotted curve 18 corresponds to the concentrations of suspended matter in the releases during an air backwashing with pulsed water, according to the pulses 16.

These pulses 16 represent the backwashing water flow plotted on the y-axis and expressed in l/h.m² (liters per hour and per m²) as a function of time T plotted on the x-axis. The curve 17 shows that the effective backwashing phase with air and water without pulsing is limited in time to a very short period. Analysis of the phenomenon leads to the conclusion that the mixture of air and water very quickly tends toward a steady-state condition of the ring flow type.

The pulses 16 according to the present invention favor and multiply the two-phase transition periods by varying the flow rate of water or air injected, and by repeating this sequence several times.

The curve 18 of releases according to the invention consists of three peaks corresponding to the three injected water pulses 16.

However, the backwashing without pulsing (curve 17) comprises only one peak substantially corresponding to the first peak of the curve 18. The concentration of suspended matter in the releases then decreases constantly.

It thereby appears that the solution according to the invention permits a much more effective unclogging.

FIG. 13 is a comparative diagram of various backwashing modes. The filtration time D expressed in weeks is plotted on the x-axis while the filtration permeability E of the membrane expressed in l/h.m².bar (liters per hour, per m₂ of membrane and per bar) is plotted on the y-axis. The more clogged the membrane, the lower the filtration permeability.

The curve 19 corresponds to the case of water/pulsed-air backwashing, according to the invention. The dashed curve 20 corresponds to the water/air backwashing without pulsings. The dotted curve 21 corresponds to backwashing with water only.

The curve 19 clearly shows that, according to the invention, the filtration permeability of the membrane is maintained over time at a substantially constant level, thanks to the efficient washing and unclogging, markedly superior to that of the curves 20 and 21, which are decreasing with a steeper slope for the curve 21.

When the filtration permeability has dropped to the value 100 l/h.m².bar, a chemical regeneration of the membrane is necessary, corresponding to the zone 22.

By combining liquid pulses with a continuous gas flow or gas pulses with continuous liquid flow during membrane filter unclogging backwashings, the invention thereby serves surprisingly and significantly to increase the removal of the filter cake as compared to a constant flow.

The interval between chemical regenerations is thereby significantly increased. By way of non-limiting example, for similar conditions, the time interval between two chemical regenerations is multiplied by 5 thanks to the invention, as compared to a conventional method.

The gain in permeability is increased, thereby decreasing the frequency of application of this type of unclogging.

The quantity of water employed is significantly decreased, thereby improving the productivity of the system.

Clogging is reduced and permits a decrease in the frequency of chemical regenerations.

1. A method for cleaning membrane filters comprising hollow fibers with an inner skin, mounted inside a housing for filtering a liquid, with delimitation of a concentrate compartment where the materials retained both in suspension and on the membranes accumulate, and a permeate compartment collecting the filtered liquid, comprising the steps consisting in:
a) draining the concentrate compartment to remove the liquid to be filtered contained therein and the suspended matter, then
b) performing a backwashing by passing liquid from the permeate compartment to the concentrate compartment through the membranes to detach and remove the impurities deposited thereon, while circulating a gas in the concentrate compartment,
wherein backwashing gas and/or liquid pulses are produced during at least one backwashing phase.

2. The method as claimed in claim 1, wherein the number of pulses during a phase is between 1 and 10.

3. The method as claimed in claim 1, wherein the pulse duration is between 2 and 60 seconds.

4. The method as claimed in claim 1 wherein the washing liquid is injected in pulses into the concentrate compartment while the circulation of gas, particularly air, is maintained in the concentrate compartment.

5. The method as claimed in claim 1, wherein the gas is injected in pulses into the concentrate compartment while the circulation of liquid is maintained in the concentrate compartment.

6. The method as claimed in claim 1, wherein, during the backwashing step, the rate of passage of the liquid in the membranes is between 0.1 and 1 m³/m².s.

7. The method as claimed in claim 1 wherein, during the backwashing step, the rate of passage of the gas is between 0 and 4 Sm³/m².s.

8. The method as claimed in claim 1, wherein the concentrate compartment drainage step is terminated by using a gas stream to accelerate and improve the drainage.

9. The method as claimed in claim 1, wherein the liquid to be filtered is water, the liquid used for the backwashing step is filtered water, and the gas circulated is air.

10. The method as claimed in claim 1, wherein the filtered liquid injected during the backwashing step into the concentrate compartment through the membranes is previously augmented with one of the following products: oxidizing agents such as chlorine compounds, peroxides, acidic or basic chemical compounds.

11. The method as claimed in claim 1, wherein the backwashing step comprises at least one two-phase cycle, that is, one phase with two fluids, liquid and gas, one of which is pulsed, and another phase with the fluid that is not pulsed.

12. The method as claimed in claim 11, wherein the number of two-phase cycles during a single backwashing step is between 1 and 10.

13. An installation for implementing a method as claimed in claim 1, comprising membrane filters in the form of hollow fibers with an inner skin mounted inside a housing, with delimitation of a concentrate compartment and a permeate compartment, a feed pump and a feed valve for the concentrate compartment, a drain valve, a backwashing pump and a backwashing valve, characterized in that it comprises a gas compressor and a valve connected to the concentrate compartment, and a control means for pulsing the flow of backwashing liquid and/or gas which can circulate in the concentrate compartment.

14. The installation as claimed in claim 13, wherein the pulse control means comprises a solenoid valve (5, 7) and a circuit (5a, 7a) for supplying said solenoid valve with electrical pulses.
